(19) United States
(12) Patent Application Publication
(10) Pub. No.: US 2009/0278658 A1
(43) Pub. Date: Nov. 12, 2009

(54) EYE IMAGE TAKING DEVICE AND AUTHENTICATION DEVICE USING THE SAME

(75) Inventor: Seiji Higashiyama, Kanagawa (JP)

Correspondence Address: WENDEROTH, LIND & PONACK L.L.P., 1030 15th Street, N.W., Suite 400 East, Washington, DC, 20005-1503, US

(73) Assignee: MATSUSHITA ELECTRIC INDUSTRIAL CO., LTD., Osaka, JP (JP)

(21) Appl. No.: 11/910,317

(22) PCT Filed: May 30, 2006
(86) PCT No.: PCT/JP2006/310727

§ 371 Date: Oct. 1, 2007

(30) Foreign Application Priority Data
Jun. 1, 2005 (JP) 2005-160978

(51) Int. Cl. G06F 7/04; H04N 7/18; G06K 9/00

(52) U.S. Cl. 340/5.82; 348/78; 348/E07.085; 382/117

(57) ABSTRACT

There are provided a first imaging unit for imaging at least an eye of an object, a second imaging unit having a focused range different from that of the first imaging unit, and arranged so as to image the same direction as that of the first imaging unit, an eye detection unit for determining whether the eye is taken in images taken by the first imaging unit and the second imaging unit, and an output unit for outputting the image determined to contain the image of the eye by the eye detection unit.

### TECHNICAL FIELD

The present invention relates to an eye imaging device for taking an image containing at least an eye of a person to be authenticated and an authentication device using the same.

### BACKGROUND ART

Recently, as a method of authenticating a person when the person accesses a device in which high security is required, such as an entering and leaving management device or information device in which important information such as personal information is stored, various kinds of authentication methods using information specific to a person to be authenticated such as a fingerprint, an iris, a blood vessel at the back of the eye, a facial feature, a blood vessel pattern of a hand or an arm, that is, biometrics information have been put into practical use.

Among them, in view of high reliability such as high authentication accuracy and low false acceptance rate, an authentication method using the difference in wrinkle pattern of an iris part of an eye (hereinafter, referred to as the “iris authentication method”) has been proposed and it has been put into practical use in a device in which especially high security is required (refer to Japanese Patent No. 3307936, for example).

According to such an iris authentication method, the iris part is selectively coded from an image of the eye (hereinafter, referred to as the “eye image”) of a person to be authenticated and this information is compared as authentication information with previously registered information (hereinafter, referred to as “registered authentication information”) and when it is determined that they coincide with each other, the person to be authenticated is recognized as the previously registered person.

In an iris authentication device using such an iris authentication method, a telescopic lens is mounted in general in order to take a clear eye image of the person to be authenticated in many cases. However, the problem is that it is difficult to focus on the eye of the person to be authenticated and take the image of it accurately just by mounting the telescopic lens as an optical system because its field angle is narrow.

In view of the above problem, there is proposed a technique capable of taking an enlarged image of the eye in which a W camera including a lens having a relatively large field angle and a movable N camera including a lens having a relatively small field angle are provided, a whole face of an object is imaged by the W camera, the position of the eye is detected from the image, and the N camera is directed to the detected eye to take the image thereof (refer to Unexamined Japanese Patent Publication No. 10-40386, for example). According to this technique, the constitution does not need a complicated optical system such as a zoom lens.

The above-described conventional iris authentication device preferably uses a relatively telescopic single focus lens as the optical system of the N camera in view of its cost. In this case, since its depth of field is too shallow, it is necessary to accurately guide the person to be authenticated within an appropriate distance range that can be focused (hereinafter, referred to as the “focused range”). However, since it is considered that the human sense of distance direction is very obtuse as compared with the sense of horizontal direction and vertical direction, the problem is that it is difficult for the person to stand at the optimal distance even after continuous use of the iris authentication device, and it is necessary to use a complicated constitution such as audio guidance for guiding the person.

### DISCLOSURE OF THE INVENTION

The present invention has been made in view of the above problem and it is an object of the present invention to provide an eye imaging device and authentication device by which it is easy to position an object at an optimal distance and there is no need to use a complicated constitution for guiding.

An eye imaging device according to the present invention includes a first imaging unit for imaging at least an eye of an object, a second imaging unit having a focused range different from that of the first imaging unit, and arranged so as to image the same direction as that of the first imaging unit, an eye determination unit for determining whether the eye is taken in images taken by the first imaging unit and the second imaging unit, and an output unit for outputting the image determined to contain the image of the eye by the eye determination unit.

According to the above constitution, since the first imaging unit and the second imaging unit having the different focused ranges from each other are arranged so that they take the images in almost the same direction, the focused range in which a clear image of the object is taken can be widened, so that the eye imaging device can easily position the object at an optimal distance and does not need to use a complicated constitution for guiding.

In addition, there may be provided an image quality determination unit for determining image qualities of the images taken by the first imaging unit and the second imaging unit, and outputting the image determined to have a good quality to the output unit.

According to the above constitution, the image determined to have the good quality is outputted among the images taken by the first imaging unit and the second imaging unit.

Furthermore, there may be provided an imaging direction conversion unit for converting the imaging direction of the first imaging unit.

According to the above constitution, the first imaging unit and the second imaging unit are arranged so that their imaging directions are different and the imaging directions can be made coincident with each other by the imaging direction conversion unit.

Furthermore, the imaging direction conversion unit may include a half mirror arranged in the imaging direction of the second imaging unit.

According to the above constitution, since the half mirror is used as the imaging direction conversion unit, the constitution can be simple.

In addition, there may be provided an imaging control unit for causing either one of the first imaging unit and the second imaging unit to take the image.

According to the above constitution, the first imaging unit and the second imaging unit may be switched to take the image according to need.

Furthermore, the imaging control unit may cause the first imaging unit and the second imaging unit to take the images alternately.

According to the above constitution, since the first imaging unit and the second imaging unit take the images alternately, the image taken by the first imaging unit or the second imaging unit can be outputted, so that it is highly likely that a preferable image can be taken.

In addition, it may be configured such that the second imaging unit has the focused range farther than that of the first imaging unit, a focused value determination unit for determining a relation between a focused value of the image taken by the second imaging unit and a predetermined threshold value is provided, and the imaging control unit causes the second imaging unit to start imaging and switches the imaging from the imaging by the second imaging unit to the imaging by the first imaging unit when the focused value determination unit determines that the focused value of the image taken by the second imaging unit varies such that it becomes beyond the predetermined threshold value and then becomes below the predetermined threshold value.

According to the above constitution, since the second imaging unit having the farther focused range starts to take the image first, it is highly likely that the object can be imaged more promptly and when the focused value detected at that time exceeds the threshold value and then becomes below the threshold value, it is determined that the object comes close, and the first imaging unit having the closer focused range thus takes the image.

In addition, it may be configured such that the second imaging unit may have the focused range farther than that of the first imaging unit, an iris diameter determination unit for determining a relation between an iris diameter of the image taken by the second imaging unit and a predetermined threshold value is provided, and the imaging control unit may cause the second imaging unit to start imaging and switches the imaging from the imaging by the second imaging unit to the imaging by the first imaging unit when the iris diameter determination unit determines that the iris diameter of the image taken by the second imaging unit varies such that it becomes beyond the predetermined threshold value.

According to the above constitution, since the second imaging unit having the farther focused range starts to take the image first, it is highly likely that the object can be imaged more promptly and when the iris diameter detected from the image exceeds the threshold value, it is determined that the object comes close, the first imaging unit having the closer focused range thus takes the image.

In addition, there may be provided an irradiation unit for irradiating at least an eye of the object.

According to the above constitution, a high-contrast image of the eye of the object can be taken.

In addition, there may be provided an irradiation unit for irradiating at least an eye of the object with a light beam and a light quantity control unit for controlling a light quantity from the irradiation unit in synchronization with the imaging control of the imaging control unit.

According to the above constitution, the image is alternately taken and the light quantity of the irradiation unit can be controlled optimally depending on the imaging unit that takes the image.

Furthermore, the light quantity control unit may reduce the light quantity from the irradiation unit when one of the first imaging unit and the second imaging unit having a closer focused range takes the image.

According to the above constitution, since the light quantity is reduced when the imaging unit having the closer focused range takes the image, power consumption can be lowered.

In addition, there may be provided a distance detection unit for detecting whether the object comes close to a predetermined distance or not, and at least one of the first imaging unit and the second imaging unit may start imaging when the distance detection unit detects that the object comes close to the predetermined distance. According to the above constitution, since the image is taken after the distance detection unit detects that the object comes close to the predetermined distance, power consumption can be lowered.

An authentication device according to the present invention includes the eye imaging device according to the present invention, and an authentication process unit for performing a predetermined authentication process using the image outputted from the output unit of the eye imaging device.

According to the above constitution, since the first imaging unit and second imaging unit having different focused ranges from each other are arranged such that they can image almost the same direction, the focused range in which the image of the object can be clearly taken can be widened, so that the authentication device can easily position the object at an optimal distance and does not need a complicated constitution for guiding.

In addition, the authentication process unit may include an authentication information creation unit for creating predetermined authentication information from the image outputted from the output unit of the eye imaging device, a collation unit for comparing and collating previously registered authentication information and the authentication information created by the authentication information creation unit, and an authentication unit for authenticating the object as a previously registered person when it is determined that the registered authentication information and the authentication information created by the authentication information creation unit coincide with each other as a result of the comparison and collation by the collation unit.

According to the above constitution, since the authentication is performed using the authentication information created from the image, the authentication can be performed accurately with a little information as compared with the case where the image is directly compared.

Furthermore, the authentication information creation unit may create authentication information of an image of an iris part of an eye from an image containing at least the eye of the object by a predetermined method, and the registered authentication information may be information created from an image of an iris part of an eye of the previously registered person by the predetermined method.

According to the above constitution, since the authentication information is creased using the image of the iris part of the eye and the authentication process is performed using the authentication information, high-precision authentication can be carried out.

As described above, according to the present invention, the eye imaging device and the authentication device can easily position the object at the optimal distance and do not need a complicated constitution for guiding.

### BRIEF DESCRIPTION OF DRAWINGS

FIG. 1 illustrates a function of an authentication device according to a first embodiment of the present invention.

FIG. 2 is a block diagram showing the constitution of the authentication device according to the first embodiment of the present invention.

FIG. 3A illustrates a constitution of a guide unit in the authentication device according to the first embodiment of the present invention.

FIG. 3B illustrates the constitution of the guide unit in the authentication device according to the first embodiment of the present invention.

FIG. 4 is a flowchart showing operation steps of the authentication device according to the first embodiment of the present invention.

FIG. 5 is a block diagram showing a constitution an authentication device according to a second embodiment of the present invention.

FIG. 6 is a flowchart to explain an operation of the authentication device according to the second embodiment of the present invention.

FIG. 7 illustrates a process of a focused value determination unit in the authentication device according to the second embodiment of the present invention.

FIG. 8 is a block diagram showing a constitution an authentication device according to a third embodiment of the present invention.

FIG. 9 is a flowchart to explain an operation of the authentication device according to the third embodiment of the present invention.

FIG. 10 illustrates a process of an iris diameter determination unit in the authentication device according to the third embodiment of the present invention.

### REFERENCE MARKS IN THE DRAWINGS

1, 101, 201 authentication device
2 distance measuring sensor unit
3 first imaging unit
4 second imaging unit
13 light source drive unit
14 capture process unit
15 image quality determination unit
16 eye detection unit
17 authentication process unit
18 iris detection unit
19 authentication information creation unit
20 collation unit
21 memory unit
22 authentication result determination unit
23 output unit
27 first light source
28 second light source
40 object
41 mirror unit
42 imaging direction conversion unit
44 focused value determination unit
45 iris diameter determination unit
48 switching unit
50 control unit
51 guide unit
52 mark
80 eye
81, 82 variation in focused value
91, 92 variation in iris diameter

### PREFERRED EMBODIMENTS FOR CARRYING OUT OF THE INVENTION

Embodiments of the present invention are described in detail with reference to the drawings hereinafter.

### First Embodiment

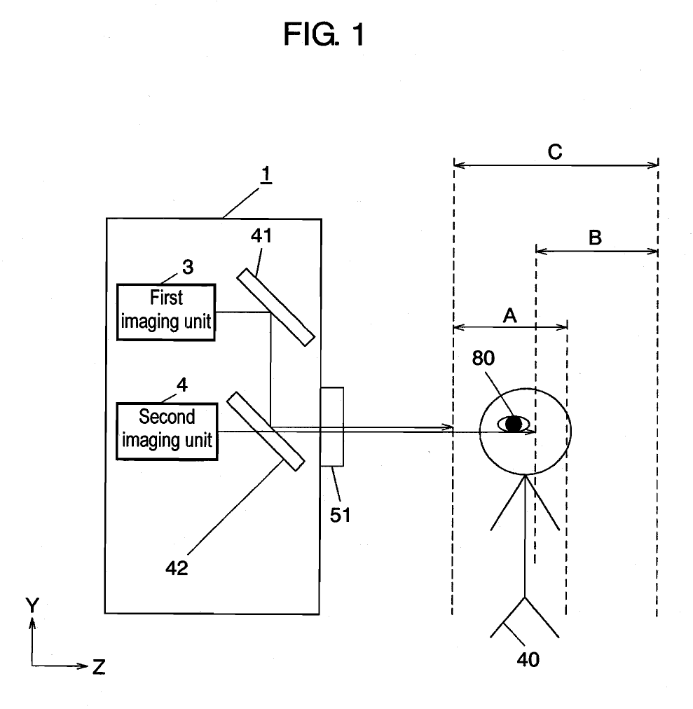

First, authentication device 1 according to a first embodiment of the present invention is described. FIG. 1 illustrates a function of authentication device 1 according to the first embodiment of the present invention. In FIG. 1, only main components of authentication device 1 are shown for simplification of the description.

Authentication device 1 according to the first embodiment of the present invention is an eye imaging device for taking an eye image of object 40 by an imaging unit, and also an iris authentication device capable of authenticating a person by performing an iris authentication process using the eye image.

Authentication device 1 according to the first embodiment of the present invention includes two imaging units, i.e., first imaging unit 3 and second imaging unit 4 each having an optical system transmitting a reflection image of object 40 and an imaging unit for outputting an optical image as an electric signal. In addition, an optical axis direction of the optical system of second imaging unit 4 is arranged so as to face a direction of eye 80 of object 40 (Z axis direction in FIG. 1) and an optical axis direction of the optical system of first imaging unit 3 is arranged so as to be parallel (Z axis direction) to the optical axis direction of second imaging unit 4. In addition, mirror unit 41 is positioned at an angle of 45° with respect to the optical axis direction of first imaging unit 3, and provided so as to reflect a light beam from a lower direction to an upper direction in FIG. 1 (Y axis direction in FIG. 1), toward the optical system of first imaging unit 3 (·Z axis direction). In addition, imaging direction conversion unit 42 including a half mirror is provided so as to be parallel to mirror unit 41 and has an incident angle of 45° with respect to the imaging optical axis direction of second imaging unit 4. In this constitution, by imaging direction conversion unit 42, half of the reflection light from object 40 transmits imaging direction conversion unit 42 and imaged by second imaging unit 4, and the other half is reflected by imaging direction conversion unit 42 and totally reflected by mirror unit 41 and imaged by first imaging unit 3. That is, in authentication device 1 according to the first embodiment of the present invention, the imaging direction of first imaging unit 3 approximately coincides with the imaging direction of second imaging unit 4 as shown in FIG. 1. In addition, as imaging direction conversion unit 42 according to the first embodiment of the present invention, a half mirror having semi-transmission characteristics with respect to a light beam in a near-infrared region can be used as will be described below. As mirror unit 41, a mirror totally reflecting a light beam in a near-infrared region can be used as will be described below.

First imaging unit 3 of authentication device 1 according to the first embodiment of the present invention includes a single focus optical system capable of obtaining a focused image in focused range A shown in FIG. 1, and second imaging unit 4 includes a single focus optical system capable of obtaining a focused image in focused range B shown in FIG. 1. In addition, practically it is desirable that each of the optical system of first imaging unit 3 and the optical system of second imaging unit 4 is an optical system capable of providing an image having almost the same magnification because a pre-process such as resizing is not needed at the time of imaging process as will be described below.

As shown in FIG. 1, according to authentication device 1 in the first embodiment of the present invention, since first imaging unit 3 having region A as the focused range and second imaging unit 4 having region B as the focused range are provided so as to take an image on almost the same axis, an image of eye 80 of object 40 can be taken in a large region shown as region C. Thus, the eye image of the object can be taken by guiding object 40 through a relatively simple method in which eye 80 is reflected in guide unit 51 having a mirror and adjusted in a horizontal direction (X axis direction) and in a vertical direction (Y axis direction) without the necessary of any particular complicating guiding of object 40 in a distance direction (Z axis direction).

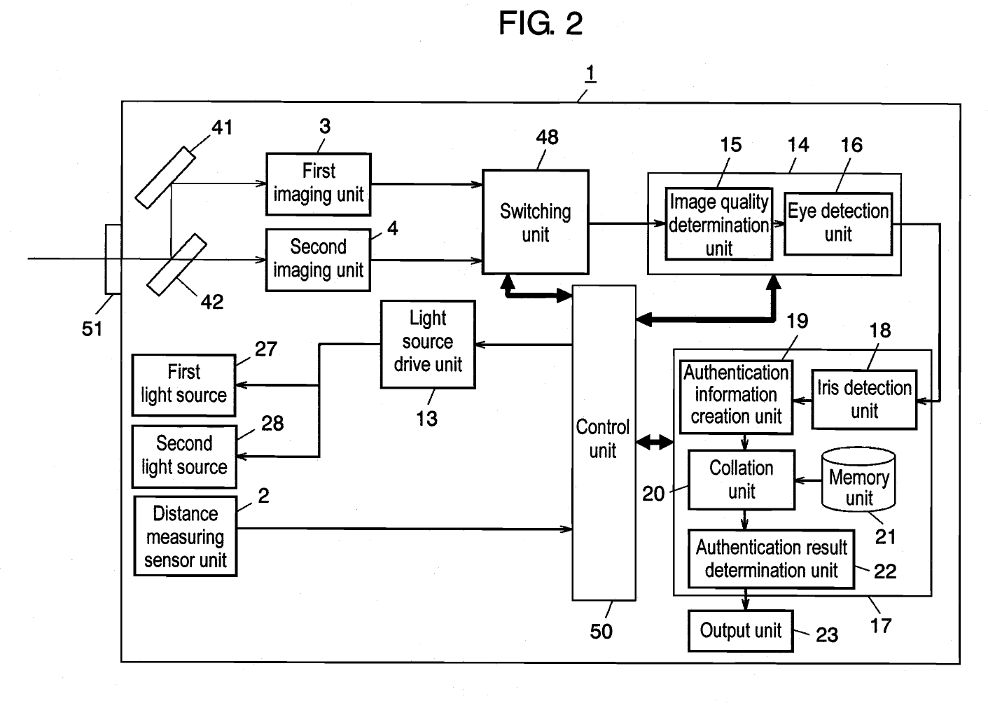

Next, the constitution of authentication device 1 according to the first embodiment of the present invention is described in further detail. FIG. 2 is a block diagram showing the constitution of authentication device 1 according to the first embodiment of the present invention.

As shown in FIG. 2, authentication device 1 according to the first embodiment of the present invention includes guide unit 51 for guiding eye 80 of object 40 in the horizontal direction and vertical direction so as to arrange it on the optical axis of first imaging unit 3 and second imaging unit 4, mirror unit 41 used in taking the image of eye 80 of object 40 guided by guide unit 51, imaging direction conversion unit 42, first imaging unit 3, second imaging unit 4, switching unit 48 for switching the images outputted from first imaging unit 3 and second imaging unit 4 and outputting the same to capture process unit 14, capture process unit 14 for performing a process in which an image that can be used in the authentication process is selected from the images outputted from switching unit 48 (this process is referred to as the “capture process” hereinafter), authentication process unit 17 for performing an iris authentication process using the image capture-processed by capture process unit 14, an output unit 23 for outputting a result whether object 40 is the previously registered person or not obtained from the result of the authentication process by authentication process unit 17, first and second light sources 27 and 28 for irradiating object 40, light source drive unit 13 for blinking first light source 27 and second light source 28, a distance measuring sensor unit 2 serving as a distance detection unit for measuring the distance to object 40, and control unit 50 connected to distance measuring sensor unit 2 for controlling each of capture process unit 14, authentication process unit 17, switching unit 48 and light source drive unit 13. Control unit 50 also functions as an imaging control unit for controlling first imaging unit 3 and second imaging unit 4 by performing switch of switching unit 48. Control unit 50 also functions as light quantity control unit for controlling light quantity of first light source 27 and second light source 28.

Capture process unit 14 and authentication process unit 17 in authentication device 1 according to the first embodiment of the present invention can repeatedly perform their processes by the instruction of control unit 50.

Capture process unit 14 has image quality determination unit 15 for determining an image quality of the image selected by switching unit 48 among the images outputted from first imaging unit 3 and second imaging unit 4, and an eye detection unit 16 serving as an eye determination unit for detecting whether there is eye 80 in the image determined to have a good quality by image quality determination unit 15. In addition, the good quality means that at least the iris part in the image is clear and can be used in the authentication process, for example.

Image quality determination unit 15 may be a focused value determination unit in which a predetermined high-frequency component is integrated from the image and when the high-frequency component amount is larger than a predetermine threshold value, it is determined that the image is in focus. In addition, image quality determination unit 15 may use a processing block including various kinds of image quality evaluations such as a luminance evaluation unit in which an average luminance of an image is calculated and it is evaluated whether the image is too bright or too dark and the like. Furthermore, the above processing blocks may be combined.

In addition, a method of implementing the function of eye detection unit 16 includes a method in which it is determined whether there is a round region (having a luminance lower than its periphery) estimated to be a pupil or black part in the image or not by a pattern matching process with the image outputted from image quality determination unit 15 and a black (low-luminance) image having a predetermined size, or a method in which an integrated value of the luminance on the circumference of the circle having a predetermined radius around a center coordinates of an expected pupil is calculated and when a variation of the integrated value with respect to the radius is not more than a predetermined threshold value, it is determined that the expected pupil is a pupil. In addition, although detailed description is omitted, the processes of image quality determination unit 15 and eye detection unit 16 may be implemented by software or hardware, and in the case of hardware, the capture process can be performed with a period of about 33 ms.

Authentication process unit 17 performs in capture process unit 14 the authentication process on the image determined to have a good quality by image quality determination unit 15 and contain a pupil or black part in the image by eye detection unit 16. Authentication process unit 17 in authentication device 1 according to the first embodiment of the present invention includes iris detection unit 18 for separating an iris part from the image outputted from capture process unit 14, authentication information creation unit 19 for creating authentication information to be used in the authentication process by a predetermined method, from the image of the iris part separated by iris detection unit 18, a memory unit 21 for storing registered authentication information of the previously registered person, a collation unit 20 for comparing and collating the registered authentication information stored in memory unit 21 and the authentication information created by authentication information creation unit 19, and authentication result determination unit 22 serving as an authentication unit for determining whether object 40 can be authenticated as the previously registered person based on the result in collation unit 20. In addition, although a detailed description is omitted, the process of each of iris detection unit 18, authentication information creation unit 19, collation unit 20, and authentication result determination unit 22 may be implemented by software or hardware, and in the case of hardware, the authentication process can be performed with a period of about 200 ms.

Here, a method of detecting the iris from the image by iris detection unit 18, a method of creating the authentication information from the image of the iris part by the authentication information creation unit 19, a method of comparing and collating by collation unit 20, and a method of determining the authentication result by authentication result determination unit 22 may use the method disclosed in the above Patent Document 1, for example. In addition, with respect to the authentication device according to the present invention, the authentication process method by authentication process unit 17 is not limited to the above method. For example, a method in which the image sent from capture process unit 14 and the image previously stored in memory unit 21 may be directly compared and collated without creating the authentication information in authentication process unit 17. However, in view of promptness, reliability and the like of the process, it is desirable that the method described in the above Patent Document 1 is used for a practical purpose.

In addition, output unit 23 in authentication device 1 according to the embodiment of the present invention may use various kinds of known outputting means such as known displaying means such as a liquid crystal display apparatus or means capable of informing object 40 of authentication result by sound, or means capable of transmitting a signal to a server device and the like connected to the outside.

In addition, distance measuring sensor unit 2 may use a sensor capable of measuring the distance to the object using infrared light. According to the embodiment of the present invention, it should be noted that a sensor capable of measuring a distance from 20 cm to 100 cm is used and in a case where object 40 comes within a predetermined distance (80 cm, for example), a signal indicating that effect is sent to control unit 50. Distance measuring sensor unit 2 in the embodiment of the present invention is arranged such that the optical axis of the infrared light therefrom faces almost the same direction as the imaging optical axes of first imaging unit 3 and second imaging unit 4.

In addition, as each of first imaging unit 3 and second imaging unit 4 in order to obtain a high-contrast image of the iris part of eye 80 of object 40, a black-and-while camera including a telescopic lens to take the image of the iris part of eye 80 of object 40, and capable of imaging near-infrared light (light beam having a wavelength of about 700 to 1000 nm) applied to eye 80 of object 40 by first light source 27 or second light source 28 may be used. According to the first embodiment of the present invention, two black-and-while cameras each including a fixed focus telescopic lens in which its horizontal angle of view is 6.8° and maximum aperture ratio is 11.0, and a CCD having a resolution of VGA are used.

According to first imaging unit 3 and second imaging unit 4 in the first embodiment of the present invention, desirable imaging distance D from their lens surface to eye 80 of object 40 is 350 mm±30 mm and an imaging range in that case is 41.6 mm in the horizontal direction×31.2 mm in the vertical direction. According to authentication device 1 in the first embodiment of the present invention, although desired imaging distance D of first imaging unit 3 and second imaging unit 4 is equal, as shown in FIG. 1, focused range A of first imaging unit 3 and focused range B of second imaging unit 4 may be different in practice. This is because, for example, as for first imaging unit 3, the distance (280 mm±30 mm in this embodiment) provided by subtracting the distance from its lens surface to mirror unit 41 (20 mm in this embodiment) and the distance from mirror unit 41 to a case through imaging direction conversion unit 42 (50 mm in this embodiment) is focused range A. In addition, as for second imaging unit 4, the distance (330 mm±30 mm in this embodiment) provided by subtracting the distance from its lens surface to the case through imaging direction conversion unit 42 (20 mm in this embodiment) is focused range B.

Thus, according to authentication device 1 in the first embodiment of the present invention, a focused image can be taken in larger range C (250 mm to 360 mm in this embodiment) with the two imaging units having the same specifications.

In addition, authentication device 1 according to the first embodiment of the present invention is the iris authentication device, so that it is necessary to take the image of the iris of eye 80 of object 40 clearly. Thus, as first light source 27 and second light source 28 in authentication device 1 according to the first embodiment of the present invention, a light source arranged so as to emit near-infrared light to the vicinity of eye 80 of object 40 is used.

These light sources are driven by light source drive unit 13 controlled by control unit 50 such that when first imaging unit 3 takes an image, first light source 27 is turned on and when second imaging unit 4 takes an image, second light source 28 is turned on. In addition, the light quantity generated from first light source 27 turned on when first imaging unit 3 having the closer focused range takes an image is adjusted so as to be smaller than that generated from second light source 28. In this constitution, according to authentication device 1 of the first embodiment of the present invention, when first imaging unit 3 focusing its lens on the closer range takes an image, the light quantity is small and when second imaging unit 4 focusing its lens on the farther range takes an image, the light quantity is large, so that the brightness of the image to be taken can be relatively uniform. Thus, when an imaging process to be described below is performed, the pre-process such as contrast adjustment can be omitted and power consumption is low as compared with the case where object 40 is always irradiated by second light source 28. In addition, the light quantities of first light source 27 and second light source 28 can be adjusted by adjusting a voltage applied to first light source 27 or second light source 28 from light source drive unit 13 or by adjusting a pulse width when the voltage is applied, for example.

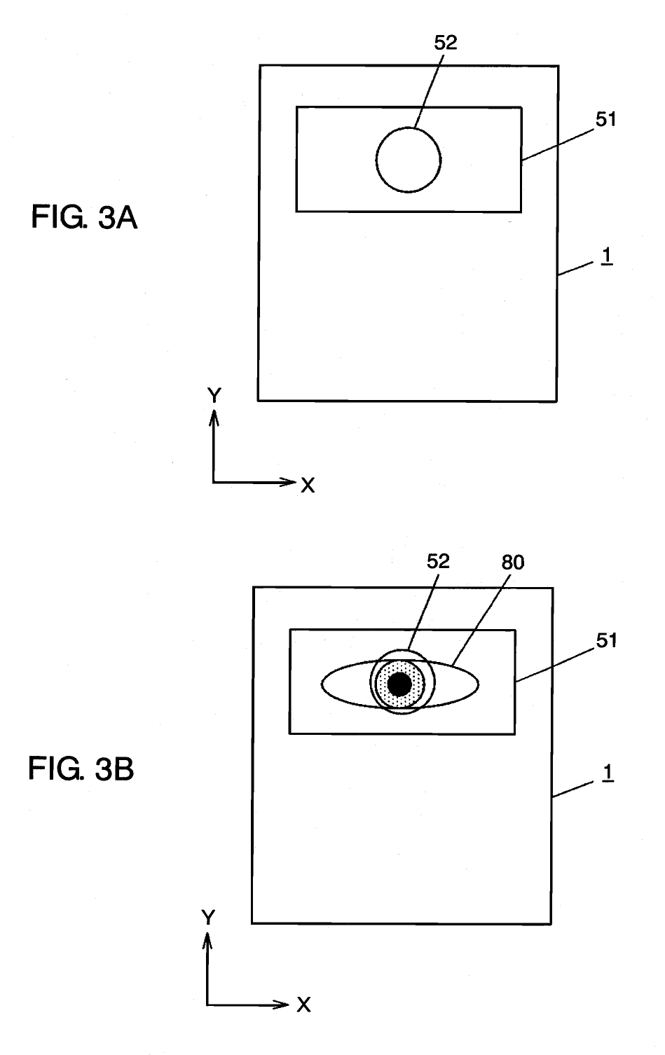

A constitution of guide unit 51 in authentication device 1 according to the first embodiment of the present invention is described. FIGS. 3A and 3B illustrate the constitution of guide unit 51 in authentication device 1 according to the first embodiment of the present invention.

As shown in FIG. 3A, according to authentication device 1 in the first embodiment of the present invention, as guide unit 51, a cold mirror reflecting visible light and transmitting infrared light can be used. When the cold mirror is used as guide unit 51, as shown in FIG. 3B, object 40 moves so that its own eye 80 can be moved to an optimal position in the horizontal direction and in the vertical direction and positioned in guide unit 51. At this time, when a circular mark 52 is provided at a position in which a black part of its own eye 80 will appear, more correct positioning can be performed in the horizontal direction (X-axis direction) and the vertical direction (Y-axis direction). In addition, mark 52 may be or may not be provided.

In addition, in the case where guide unit 51 in authentication device 1 according to the first embodiment of the present invention is used, it is difficult to guide the distance (Z direction) between object 40 and authentication device 1 to an optimal position, but according to authentication device 1 in the first embodiment of the present invention, since first imaging unit 3 and second imaging unit 4 are provided, a larger focused range can be realized, so that necessity for guiding in the distance direction can be considerably reduced.

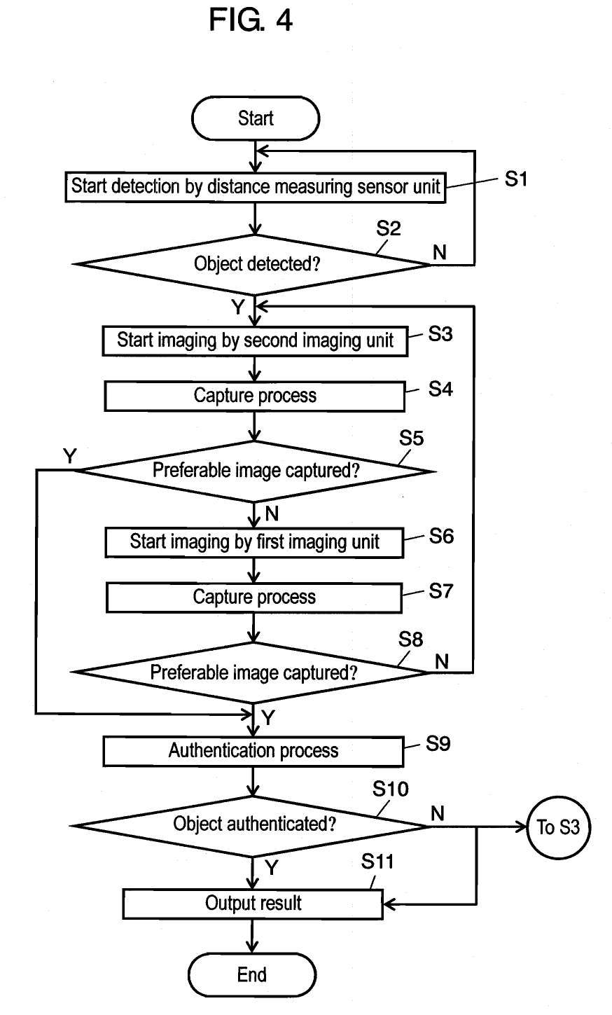

Here, the operation of authentication device 1 according to the first embodiment of the present invention is described in detail. FIG. 4 is a flowchart showing operation steps of authentication device 1 according to the first embodiment of the present invention.

First, in authentication device 1 according to the first embodiment of the present invention, control unit 50 activates distance measuring sensor unit 2 and distance measuring sensor unit 2 starts to detect whether object 40 enters a predetermined distance range or not (S1).

Distance measuring sensor unit 2 continues to detect object 40 until object 40 enters the predetermined distance range (N) (S2), and when object 40 enters the predetermined distance range (Y), it notifies control unit 50 of the fact, and control unit 50 controls switching unit 48 such that second imaging unit 4 having the focused range at the farther place starts to take an image (S3). Here, the reason why second imaging unit 4 starts to take an image first is that since in general, object 40 approaches from a distance in many cases, when second imaging unit 4 having the focused range at the farther place takes an image first, it is highly likely that the image of object 40 can be captured as compared with a case where first imaging unit 3 takes an image first. In addition, at this time, control unit 50 controls light source drive unit 13 to turn on second light source 28.

The image taken by second imaging unit 4 is sent to capture process unit 14 through switching unit 48 and the above-described capture process is performed (S4).

When the image determined to have a good quality and contain the image of eye 80 is obtained (captured) in capture process unit 14 (Y), the operation proceeds to step S9 and when it is not captured (N), control unit 50 turns off second light source 28 and then controls switching unit 48 to stop the output from second imaging unit 4 and to start the output from first imaging unit 3, and turns on first light source 27 (S6).

The image taken by first imaging unit 3 is sent to capture process unit 14 through switching unit 48 and the above capture process is performed (S7).

When the image determined to have a good quality and contain the image of eye 80 is obtained (captured) in capture process unit 14 (Y), the operation proceeds to step S9 and when it is not captured (N), control unit 50 controls switching unit 48 to stop the output from first imaging unit 3 and turns off first light source 27 and then makes second imaging unit 4 start imaging (S8), returning to step S3.

The image captured in step S8 in FIG. 4 is sent to authentication process unit 17 (Y) and the above-described authentication process is performed (S9).

As a result, when object 40 is authenticated as the previously registered person (Y), the operation proceeds to step S11 and the result is outputted from output unit 23 and the processes are completed (S11) but when object 40 cannot be authenticated as the previously registered person (N), that effect is outputted from output unit 23 and the processes are completed, or the operation returns to the step S3 and the eye image is taken again (S10).

Thus, according to authentication device 1 in the first embodiment of the present invention, the eye image of object 40 can be taken and authentication can be performed by an iris authentication method using the eye image.

As described above, according to authentication device 1 in the first embodiment of the present invention, since first imaging unit 3 and second imaging unit 4 having different focused ranges are arranged such that their imaging axes approximately coincide with each other, to take the image of eye 80 of object 40, the focused range can be widely provided and the eye image can be naturally taken without any complicated guiding for object 40 in the distance direction.

### Second Embodiment

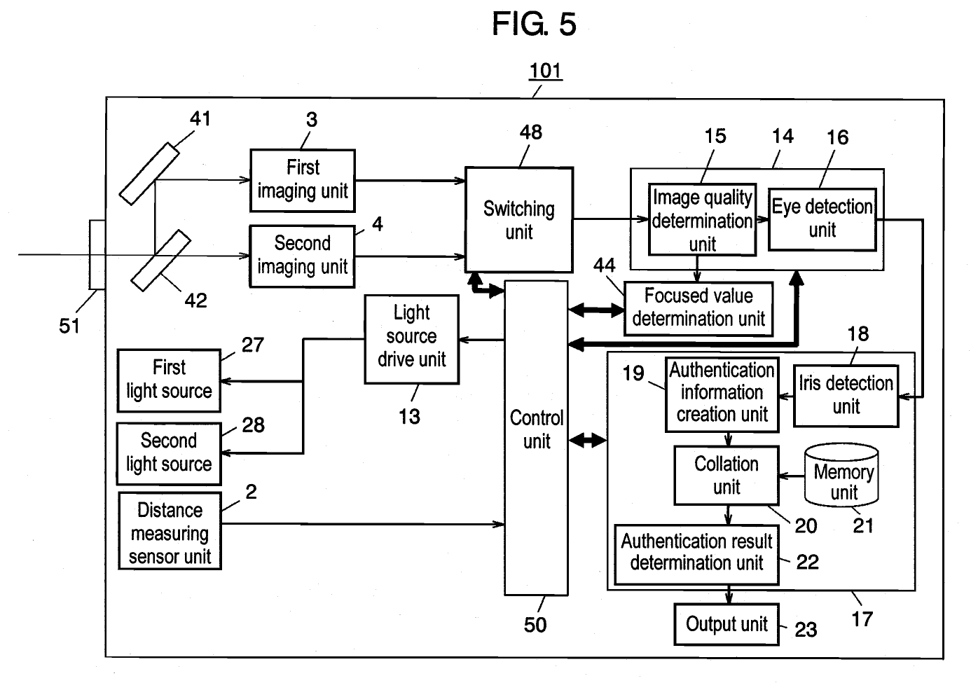

Next, a constitution of authentication device 101 according to a second embodiment of the present invention is described. FIG. 5 is a block diagram showing the constitution of authentication device 101 according to the second embodiment of the present invention.

As shown in FIG. 5, the constitution of authentication device 101 according to the second embodiment of the present invention is different from authentication device 1 according to the first embodiment of the present invention in that it includes focused value determination unit 44 for comparing a focused value of an output of image quality determination unit 15 of capture process unit 14 with a predetermined threshold value and determining its result. It should be noted that focused value determination unit 44 is also controlled by control unit 50. Since other components are the same as those in authentication device 1 in the first embodiment of the present invention, the same signs are allotted to the same components and their descriptions are omitted.

According to the second embodiment of the present invention, as an image quality determining method of image quality determination unit 15, among the above-described methods, the method in which a predetermined high-frequency component is integrated from the image and when the amount of the high-frequency component is larger than a predetermined threshold value, it is determined that the image is in focus is used. A value indicating a focused degree (focused value) provided by integrating the predetermined high-frequency component from the image is outputted from image quality determination unit 15 to focused value determination unit 44 with respect to each image, and focused value determination unit 44 performs a determination process as will be described below using the focused value.

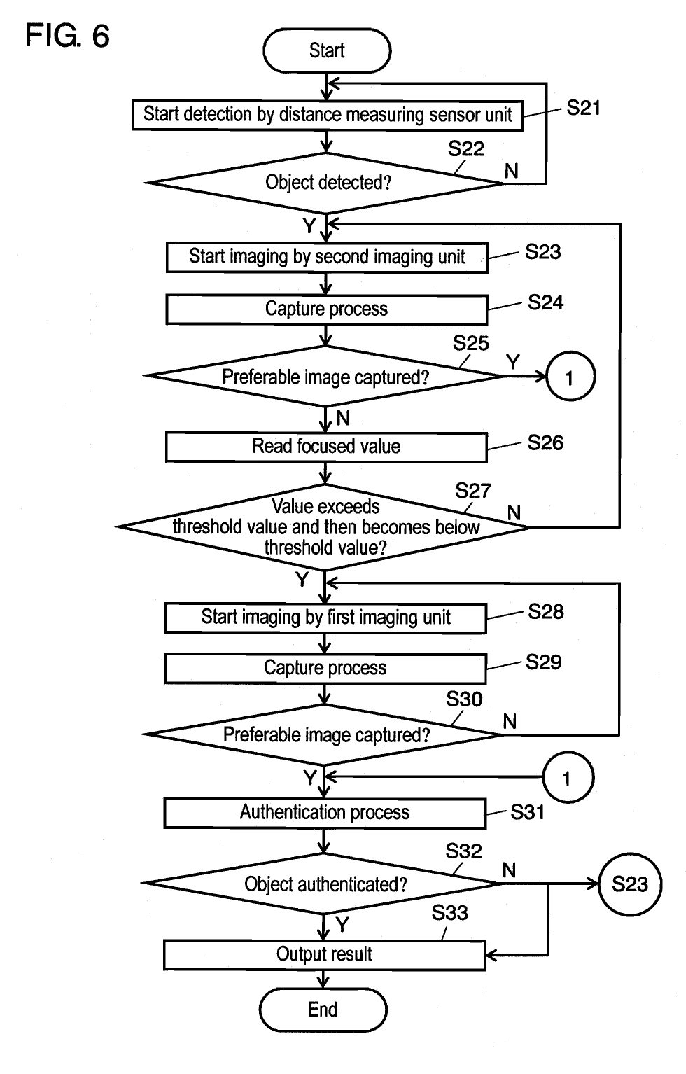

Here, an operation of authentication device 101 according to the second embodiment of the present invention is described in detail. FIG. 6 is a flowchart showing operation steps of authentication device 101 according to the second embodiment of the present invention.

First, in authentication device 101 according to the second embodiment of the present invention, control unit 50 activates distance measuring sensor unit 2 and distance measuring sensor unit 2 starts to detect whether object 40 enters a predetermined distance range or not (S21).

Distance measuring sensor unit 2 continues to detect object 40 until object 40 enters the predetermined distance range (N) (S22), and when object 40 enters the predetermined distance range (Y), it notifies control unit 50 of the fact, and control unit 50 controls switching unit 48 such that second imaging unit 4 having the focused range at the farther place starts to take an image (S23). Here, the reason why second imaging unit 4 starts to take an image first is that since in general, object 40 approaches from a distance in many cases, when second imaging unit 4 having the focused range at the farther place takes an image first, it is highly likely that the image of object 40 can be captured as compared with a case where first imaging unit 3 takes an image first. In addition, at this time, control unit 50 controls light source drive unit 13 to turn on second light source 28.

The image taken by second imaging unit 4 is sent to capture process unit 14 through switching unit 48 and the above-described capture process is performed (S24).

When the image determined to have a good quality and contain the image of eye 80 is obtained (captured) in capture process unit 14 (Y), the operation proceeds to step S31 and when it is not captured (N), control unit 50 makes focused value determination unit 44 read the focused value calculated by image quality determination unit 15 and make determination as follows (S26).

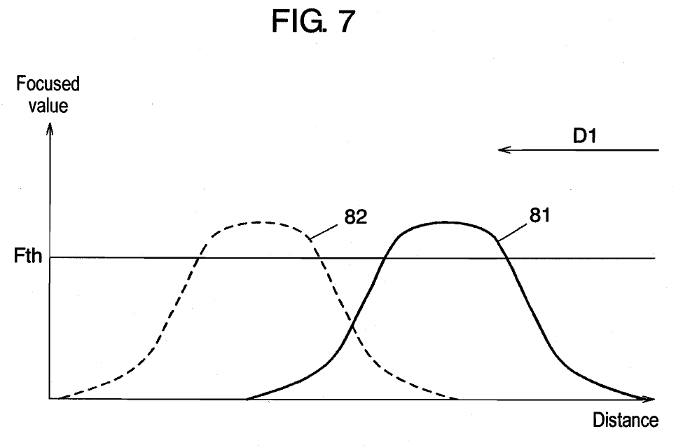

Here, a process of focused value determination unit 44 in authentication device 101 according to the second embodiment of the present invention is described. FIG. 7 illustrates the process of focused value determination unit 44 of authentication device 101 in the second embodiment of the present invention. FIG. 7 schematically shows variation 81 in focused value calculated from the image taken by second imaging unit 4 and variation 82 in focused value calculated from the image taken by first imaging unit 3 when the distance from authentication device 101 to object 40 is plotted on the horizontal axis and the focused value calculated by image quality determination unit 15 is plotted on the vertical axis. In such a relation, it is assumed that the object approaches authentication device 101 from a distance, that is, it moves in a direction of an arrow D1 in FIG. 7. At this time, the capture process is performed for the image taken by second imaging unit 4 and the focused value of the image taken by second imaging unit 4 varies from the right side to the left side in FIG. 7. That is, the focused value increases once and then decreases.

Focused value determination unit 44 in authentication device 101 according to the second embodiment of the present invention determines this variation. That is, after the focused value calculated by image quality determination unit 15 has increased beyond predetermined threshold value Fth, when it decreases below predetermined threshold value Fth, control unit 50 determines that object 40 is closer than focused range B of second imaging unit 4 and instructs switching unit 48 to switch the imaging unit from second imaging unit 4 to first imaging unit 3 having closer focused range A. In addition, predetermined threshold value Fth can usually be the threshold value used in determining whether the image quality is good or not by image quality determination unit 15. With this process, in the case where object 40 approaches, even when its preferable eye image cannot be captured because the eye is closed or not fully opened while it exits in focused range B of second imaging unit 4, since the capture process is performed by switching to first imaging unit 3 having closer focused range A, it can be highly likely that a preferable eye image can be taken while it exists in focused range A of first imaging unit 3.

Referring to FIG. 6 again, when focused value determination unit 44 determines that the focused value calculated by image quality determination unit 15 has increased beyond predetermined threshold value Fth and then decreased below predetermined threshold value Fth again (S27), control unit 50 makes switching unit 48 switch the output from the image taken by second imaging unit 4 to the image taken by first imaging unit 3 (S28).

Meanwhile, in another case in step S27, that is, when focused value determination unit 44 does not determine that the focused value calculated by image quality determination unit 15 has increased beyond predetermined threshold value Fth and then decreased below predetermined threshold value Fth again (S27), it is determined that object 40 exists in focused range B of second imaging unit 4 and the operation returns to step S23 and control unit 50 makes capture process unit 14 continue the capture process (S27).

In step S28, control unit 50 makes light source drive unit 13 turn off second light source 28 and makes switching unit 48 stop the output from second imaging unit 4 and start the output from first imaging unit 3 and turn on first light source 27 (S28).

The image taken by first imaging unit 3 is sent to capture process unit 14 through switching unit 48 and the above-descried capture process is performed (S29).

When an image in which the image quality is preferable and eye 80 is taken is obtained (captured) in capture process unit 14, the operation proceeds to step S31 and when it is not captured, the operation returns to step S28 and the capture process is performed for the image taken by first imaging unit 3 (S30).

The image captured in step S30 shown in FIG. 6 is sent to authentication process unit 17 and the above-described authentication process is performed (S31).

As a result, when object 40 is authenticated as the previously registered person, the operation proceeds to step S33 and the result is outputted from output unit 23 and the processes are completed (S33). Meanwhile, when object 40 cannot be authenticated as the previously registered person, that effect is outputted from output unit 23 and the processes are completed, or the operation returns to step S23 and an eye image is taken again (S32).

Thus, according to authentication device 101 in the second embodiment of the present invention, the eye image of object 40 approaching from a distance can be surely taken and the authentication can be performed using the eye image by the iris authentication method.

As described above, when the image of eye 80 of object 40 is taken, first imaging unit 3 and second imaging unit 4 having different focused ranges from each other are arranged so that their imaging optical axes approximately coincide with each other in authentication device 101 according to the second embodiment of the present invention also, so that the focused range can be widely provided and the eye image can be naturally taken without any complicated guiding for object 40 in the distance direction.

### Third Embodiment

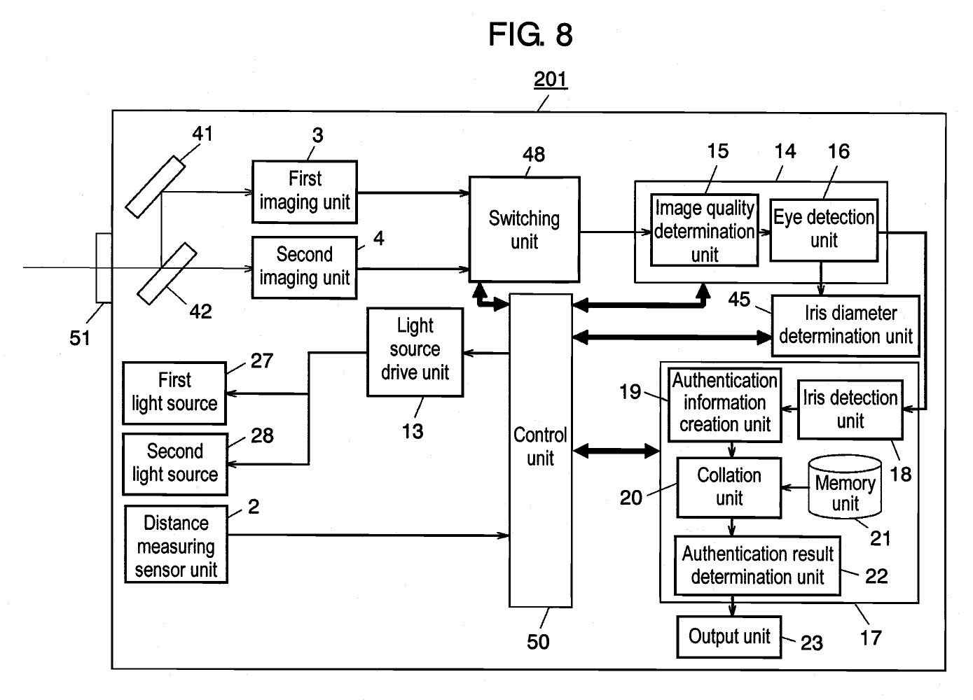

Next, a constitution of authentication device 201 according to a third embodiment of the present invention is described. FIG. 8 is a block diagram showing the constitution of authentication device 201 according to the third embodiment of the present invention.

As shown in FIG. 8, the constitution of authentication device 201 according to the third embodiment of the present invention is different from authentication device 1 according to the first embodiment of the present invention in that it includes iris diameter determination unit 45 for comparing an iris diameter value that is an output of eye detection unit 16 of capture process unit 14 with a predetermined threshold value and determining its result. It should be noted that iris diameter determination unit 45 is also controlled by control unit 50. Since other components are the same as those in authentication device 1 in the first embodiment of the present invention, the same signs are allotted to the same components and their descriptions are omitted.

According to the third embodiment of the present invention, a partial image corresponding to an iris of an eye is detected from an image and outputted by eye detection unit 16, and iris diameter determination unit 45 calculates the iris diameter from the part corresponding to the iris and compares it with the threshold value as will be described below and outputs its result to control unit 50.

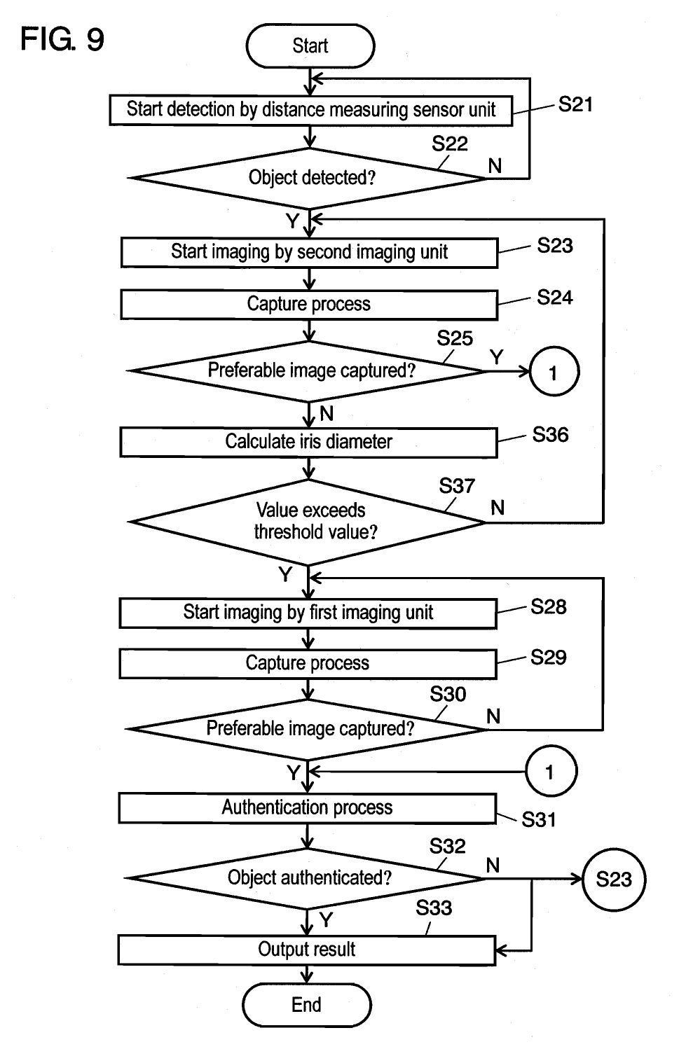

Here, an operation of authentication device 201 according to the third embodiment of the present invention is described in detail. FIG. 9 is a flowchart showing operation steps of authentication device 201 according to the third embodiment of the present invention.

In addition, in the flowchart shown in FIG. 9, the same signs are allotted to the same process steps as in the flowchart showing the operation of authentication device 101 in the second embodiment of the present invention shown in FIG. 6 and their descriptions are omitted.

The operation steps of authentication device 201 according to the third embodiment of the present invention shown in FIG. 9 are different from the operation steps of authentication device 101 according to the second embodiment of the present invention shown in FIG. 6 in that step S26 and step S27 are replaced with iris diameter calculation step S36 and threshold value determination step S37, respectively.

When the image determined to have a good quality and contain the image of eye 80 is obtained (captured) in capture process unit 14 (Y) in steps S24 and S25 in FIG. 9, the operation proceeds to step S31 and when it is not captured (N), control unit 50 makes iris diameter determination unit 45 calculate an iris diameter detected by eye detection unit 16 and make determination as follows (S36).

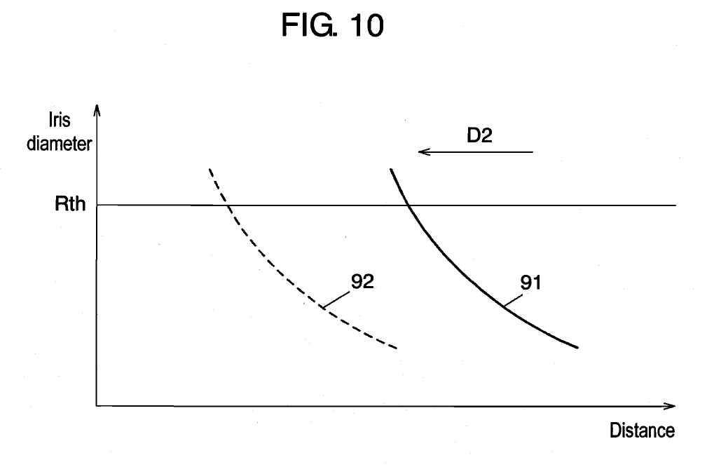

Here, a process of iris diameter determination unit 45 in authentication device 201 according to the third embodiment of the present invention is described. FIG. 10 illustrates the process of iris diameter determination unit 45 of authentication device 201 according to the third embodiment of the present invention. FIG. 10 schematically shows variation 91 in iris diameter calculated from the image taken by second imaging unit 4 and variation 92 in iris diameter calculated from the image taken by first imaging unit 3 when the distance from authentication device 201 to object 40 is plotted on the horizontal axis and the iris diameter value detected by eye detection unit 16 at that time is plotted on the vertical axis. In such a relation, it is assumed that object 40 approaches authentication device 201 from a distance, that is, it moves in a direction of an arrow D2 in FIG. 10. At this time, the capture process is performed for the image taken by second imaging unit 4 and the iris diameter calculated from the image taken by second imaging unit 4 varies from the right side to the left side in FIG. 10. That is, the iris diameter increases as object 40 approaches.

Iris diameter determination unit 45 in authentication device 201 according to the third embodiment of the present invention determines this variation. That is, when the iris diameter value calculated by eye detection unit 16 increases beyond predetermined threshold value Rth, control unit 50 determines that object 40 is closer than focused range B of second imaging unit 4 and instructs switching unit 48 to switch the imaging unit from second imaging unit 4 to first imaging unit 3 having closer focused range A. In addition, predetermined threshold value Rth may be an iris diameter value at the closest position in focused range B of second imaging unit 4 (300 mm in the embodiment of the present invention). With such a process, in the case where object 40 approaches, while it exists in focused range B of second imaging unit 4, even when a preferable eye image is not captured because object 40 wears glasses and reflection light of the light source enters the iris and the like, since the imaging is switched to first imaging unit 3 having closer focused range A and the capture process is performed, it is highly likely that a preferable eye image can be taken while the object exists in focused range A of first imaging unit 3. In addition, when object 40 is close to authentication device 201, since the angle formed between the light source and object 40 becomes large, the reflection light on the glasses moves outward, so that it is not likely that the reflection light enters the iris.

Referring to step S37 in FIG. 9 again, when iris diameter determination unit 45 determines that the iris diameter value calculated by eye detection unit 16 increases beyond predetermined threshold value Rth (Y), control unit 50 makes switching unit 48 switch the output from the image taken by second imaging unit 4 to the image taken by first imaging unit 3 (S28).

Meanwhile, in another case in step S37, that is, when iris diameter determination unit 45 does not determine that the iris diameter value calculated by eye detection unit 16 increases beyond predetermined threshold value Rth (N), it is determined that object 40 is positioned in focused range B of second imaging unit 4 and the operation returns to S23 and control unit 50 makes capture process unit 14 continue its capture process again, which is the same as that in authentication device 1 in the second embodiment of the present invention.

Thus, according to authentication device 201 in the third embodiment of the present invention also, the eye image of object 40 approaching from a distance can be surely taken and the eye image is used in the authentication by the iris authentication method.

As described above, when the image of eye 80 of object 40 is taken, first imaging unit 3 and second imaging unit 4 having different focused ranges from each other are arranged so that their imaging optical axes approximately coincide with each other in authentication device 201 according to the third embodiment of the present invention also, so that the focused range can be widely provided and the eye image can be naturally taken without any complicated guiding for object 40 in the distance direction.

In addition, although the description has been made of the constitution in which iris diameter determination unit 45 compares the iris diameter (or radius) detected by the eye detection unit 16 with predetermined threshold value Rth in the third embodiment of the present invention, the present invention is not limited to this constitution. For example, when eye detection unit 16 detects a pupil, iris diameter determination unit 45 may calculate a diameter or a radius of the pupil detected by eye detection unit 16 and compare it with a predetermined threshold value.

In addition, although the description has been made of the case where authentication devices 1, 101 and 201 perform personal authentication using the iris authentication method as the process method of authentication process unit 17 in the above embodiments, the authentication device according to the present invention is not limited to the iris authentication device. For example, the present invention can be applied to an authentication device using a face of a person to be authenticated, such as face authentication and retina authentication.

### INDUSTRIAL APPLICABILITY

As described above, according to the present invention, since the eye imaging device and the authentication device in which the object can be easily positioned at the optimal distance without using a complicated constitution for guiding the object can be provided, the present invention is advantageously applied to an eye imaging device for taking an image at least containing an eye of a person to be authenticated and an authentication device using the same.

1. An eye imaging device comprising:
a first imaging unit for imaging at least an eye of an object;
a second imaging unit having a focused range different from that of the first imaging unit, the second imaging unit being arranged to image the same direction as that of the first imaging unit;
an eye determination unit for determining whether the eye is taken in images taken by the first imaging unit and the second imaging unit; and
an output unit for outputting the image determined to contain the image of the eye by the eye determination unit.

2. The eye imaging device according to claim 1, further comprising:
an image quality determination unit for determining image qualities of the images taken by the first imaging unit and the second imaging unit, and outputting the image determined to have a good quality, to the output unit.

3. The eye imaging device according to claim 1, further comprising:
an imaging direction conversion unit for converting the imaging direction of the first imaging unit.

4. The eye imaging device according to claim 3, wherein
the imaging direction conversion unit includes a half mirror arranged in the imaging direction of the second imaging unit.

5. The eye imaging device according to claim 1, further comprising an imaging control unit for causing either one of the first imaging unit and the second imaging unit to take the image.

6. The eye imaging device according to claim 5, wherein
the imaging control unit causes the first imaging unit and the second imaging unit to take the images alternately.

7. The eye imaging device according to claim 5, wherein
the second imaging unit has the focused range farther than that of the first imaging unit,
the eye imaging device further comprises a focused value determination unit for determining a relation between a focused value of the image taken by the second imaging unit and a predetermined threshold value, and
the imaging control unit causes the second imaging unit to start imaging and switches the imaging from the imaging by the second imaging unit to the imaging by the first imaging unit when the focused value determination unit determines that the focused value of the image taken by the second imaging unit varies such that it becomes beyond the predetermined threshold value and then becomes below the predetermined threshold value.

8. The eye imaging device according to claim 5, wherein
the second imaging unit has the focused range farther than that of the first imaging unit,
the eye imaging device further comprises an iris diameter determination unit for determining a relation between an iris diameter of the image taken by the second imaging unit and a predetermined threshold value, and
the imaging control unit causes the second imaging unit to start imaging and switches the imaging from the imaging by the second imaging unit to the imaging by the first imaging unit when the iris diameter determination unit determines that the iris diameter of the image taken by the second imaging unit varies such that it becomes beyond the predetermined threshold value.

9. The eye imaging device according to claim 1, further comprising an irradiation unit for irradiating at least an eye of the object.

10. The eye imaging device according to claim 5, further comprising:
an irradiation unit for irradiating at least an eye of the object with a light beam; and
a light quantity control unit for controlling a light quantity from the irradiation unit in synchronization with the imaging control of the imaging control unit.

11. The eye imaging device according to claim 10, wherein
the light quantity control unit reduces the light quantity from the irradiation unit when one of the first imaging unit and the second imaging unit having a closer focused range takes the image.

12. The eye imaging device according to claim 1, further comprising:
a distance detection unit for detecting whether the object comes close to a predetermined distance or not, wherein
at least one of the first imaging unit and the second imaging unit starts imaging when the distance detection unit detects that the object comes close to the predetermined distance.

13. An authentication device comprising:
the eye imaging device according to claim 1, and
an authentication process unit for performing a predetermined authentication process using the image outputted from the output unit of the eye imaging device.

14. The authentication device according to claim 13, wherein
the authentication process unit includes:
an authentication information creation unit for creating predetermined authentication information from the image outputted from the output unit of the eye imaging device;
a collation unit for comparing and collating previously registered authentication information and the authentication information created by the authentication information creation unit; and
an authentication unit for authenticating the object as a previously registered person when it is determined that the registered authentication information and the authentication information created by the authentication information creation unit coincide with each other as a result of the comparison and collation by the collation unit.

15. The authentication device according to claim 14, wherein
the authentication information creation unit creates authentication information of an image of an iris part of an eye from an image containing at least the eye of the object by a predetermined method, and
the registered authentication information is information created from an image of an iris part of an eye of the previously registered person by the predetermined method.
